(19) United States
(12) Patent Application Publication
(10) Pub. No.: US 2014/0225021 A1
(43) Pub. Date: Aug. 14, 2014

(54) METHOD FOR PRODUCING A DISPERSION AND USE OF PROTEIN HYDROLYSATES AS DISPERSANTS

(71) Applicant: OTC GmbH, Oberhausen (DE)

(72) Inventors: Gerd Dahms, Duisburg (DE); Andreas Jung, Duisburg (DE)

(73) Assignee: OTC GMBH, Oberhausen (DE)

(21) Appl. No.: 14/345,868

(22) PCT Filed: Sep. 17, 2012
(86) PCT No.: PCT/EP2012/068260

§ 371 Date: Mar. 19, 2014

(30) Foreign Application Priority Data
Sep. 21, 2011 (DE) 10 2011 053 829.1

(51) Int. Cl. B01F 17/00; C11D 1/32; B03D 1/016; C09D 17/00

(52) U.S. Cl. CPC B01F 17/005; C09D 17/008; C09D 17/007; C11D 1/32; B03D 1/016
USPC 252/61; 106/501.1; 106/448; 106/429; 510/189; 510/513

(57) ABSTRACT

The present invention relates to a method for producing a dispersion and to the use of a protein hydrolysate as a dispersant or dispersing agent. In particular, the invention relates to a method for producing a suspension as well as the use of a protein hydrolysate as a dispersant in a suspension. According to the invention it is proposed to use in particular hydrolysates of proteins with a consecutive sequence of amino acids with polar and nonpolar side groups as dispersants.

### CROSS-REFERENCE TO RELATED APPLICATIONS

This application is a National Stage of International Application No. PCT/EP2012/068260, filed on Sep. 17, 2012, and published in German as WO 2013/041492 A1 on Mar. 28, 2013. This application claims the benefit and priority of German Application No. 10 2011 053 829.1, filed on Sep. 21, 2011. The entire disclosures of the above applications are incorporated herein by reference.

### BACKGROUND

This section provides background information related to the present disclosure which is not necessarily prior art.

1. Technical Field

The present invention relates to a method for producing a dispersion and to the use of a protein hydrolysate as a dispersant or dispersing agent. In particular, the invention relates to a method for producing a suspension and to the use of a protein hydrolysate as a dispersant in a suspension.

2. Discussion

Dispersions play an important role in various areas of technology. Dispersion in general refers to heterogeneous mixtures of substances which otherwise cannot be dissolved in each other. These can be either mixtures of substances of the same aggregate state or mixtures of substances of different aggregate states. The substance to be dispersed within a medium is referred to as a dispersed or disperse phase while the medium in which the disperse phase is to be distributed is referred to as a dispersing agent or dispersant. Depending on the aggregate state of the disperse phase and the dispersant one speaks of a mixture (solid/solid), a suspension (solid/liquid) or an emulsion (liquid/liquid). Other forms of dispersions are foams (gas/liquid) and aerosols (liquid/gas).

Moreover, dispersions can be distinguished with respect to the particle size of the disperse phase. For a particle size of the disperse phase of <1 nm one speaks of a molecularly dispersively dissolved phase, for a particle size between 1 nm and 1 μm in general of a colloidally dissolved phase and for a particle size of >1 μm of a coarse dispersively dissolved phase.

A technically important form of dispersions are suspensions, that is the mixtures of solids in liquids. Herein, the liquids can either be aqueous systems or hydrophobic materials such as oils. Examples of industrially used suspensions are wall or ceiling paints. In addition, suspensions, for example, are applied in flotation processes as used in the field of ore or coal processing or in the paper manufacture. In the field of detergent technique suspensions play a crucial role, too, since here dirt particles of the fabric to be cleaned have to be transferred into the washing liquor.

Hitherto surfactants are used as dispersants for producing dispersions. Surfactants have the characteristic to lower the interfacial tension between two different phases within a system. This characteristic is caused by the fact that surfactants include hydrophilic and hydrophobic regions in their molecular structure. While, for example, in an aqueous dispersion the hydrophilic regions of the surfactant orient toward the aqueous phase, the hydrophobic regions orient toward the disperse phase, for example, a solid. By this type of orientation the interfacial tension prevailing between the immiscible phases is reduced in such an extent that a corresponding dispersion of the disperse phase within the dispersion medium is enabled.

All surfactants include a polar hydrophilic portion as well as a nonpolar hydrophobic portion in their molecular structure. Depending on the charge of the polar portion of the molecular structure one distinguishes between nonionic, anionic, cationic and amphoteric surfactants.

Another class of compounds which is used as a surface active dispersant are poloxamers. Poloxamers are block copolymers of ethylene oxide and propylene oxide, which have hydrophilic and hydrophobic regions. Herein, the ethylene oxide units form the hydrophilic portion, while the propylene oxide units form the hydrophobic portion such that the amphiphilic characteristics are obtained. The poloxamers are low foaming and foam-suppressing nonionic surfactants, which are used for dispergation and emulsification in the chemical-technical industry.

A disadvantage in particular of poloxamers is that they often have only a very limited biodegradability.

### SUMMARY OF THE INVENTION

It is therefore an object of the present invention to provide an alternative method for producing a dispersion.

This object is achieved by a method according to the teachings of the present disclosure. Embodiments of the method according to the invention can be found in the following description.

Surprisingly it has been found that protein hydrolysates are suitable as dispersants for the production of dispersions.

Proteins serve as material carriers of life and can be found, inter alia, as contractile proteins in muscles, collagen fibers in tendons and connective tissue, keratins in skin and hair or feathers. They are available in very large quantities as a raw material base and can be converted in protein hydrolysates by hydrolysis.

Proteins themselves are composed of α-amino acids which are bonded to chains with each other by peptide bonds. The chains thus formed orient themselves over hydrogen bridge bonds in their secondary structure in α-helices, β-sheets, β-turns or random coil structures, which in turn orient themselves in their tertiary structure over disulfide bridges. The previously known proteinogenic amino acids from which proteins are formed have the following general primary structure:

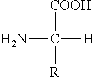

All amino acids found in proteins are αamino acids, i.e., they carry an amino group in an α-position to the carboxyl group. The individual amino acids differ in their residues R. According to these different side groups the amino acids can be classified into 4 groups:

Amino acids with nonpolar side groups. These include glycine, alanine, valine, leucine, isoleucine, methionine, phenylalanine, tryptophan and proline.

Amino acids with polar, but uncharged side groups. These include serine, threonine, cysteine, tyrosine, asparagine, and glutamine.

Amino acids with polar alkaline side groups. These include lysine, arginine and histidine.

Amino acids with polar acidic side groups. These include aspartic acid and glutamic acid.

Surprisingly it has been found that, when in the arrangement of the various amino acids consecutive sequences of amino acids with nonpolar and polar side groups are obtained, a corresponding protein hydrolysate comprises a surfactant character with hydrophilic and hydrophobic regions, similar to surfactant-poloxamers. Similar to surfactant systems protein hydrolysates are capable of lowering the surface tension of a liquid or the interfacial tension between two phases and to enable or assist in the formation of dispersions.

If, for example, a protein hydrolysate comprising amino acids with consecutive sequences of amino acids with nonpolar and polar side groups is added in water, the individual hydrolysate molecules organize when exceeding a critical concentration and form aggregates of micelles within the water. The critical micelle forming concentration can be determined uniquely by means of interfacial tension measurements.

Protein hydrolysates having a surfactant structure similar to that of block copolymers are in contrast thereto quickly biodegradable and can be produced with low energy consumption from renewable natural resources. By using the method of the invention both economic and significant environmental benefits are obtained.

In one embodiment of the method according to the invention water, an aqueous solution or a hydrophobic solvent is provided as a dispersant. Aqueous solution in the sense of the present invention means a system comprising a predominant amount of water. This can also include aqueous emulsions. Hydrophobic solvents in the sense of the present invention are, for example, lipids in general, higher alcohols and nonpolar organic solvents. In particular, in the sense of the present invention hydrophobic solvents are oils and fats, such as mono-, di-, or triglycerides.

According to a further embodiment of the method according to the invention a solid or liquid phase immiscible in the provided dispersant is provided as the disperse phase. Insofar, the method according to the invention is suitable to produce both suspensions and emulsions. In the case of a suspension the particle size of the disperse phase may be in the range between 1 nm and 1 mm according to the invention.

According to a further embodiment of the method according to the invention a hydrolysate of a protein having a consecutive sequence of amino acids with polar and nonpolar groups is provided as a protein hydrolysate. Surprisingly it has been found that in particular hydrolysates of proteins having a corresponding consecutive sequence of amino acids with polar and nonpolar side groups are suited to develop a surfactant effect.

In a further embodiment of the method according to the invention a keratin hydrolysate is provided as a dispersant. In particular, keratin hydrolysates exhibit sequences of amino acids having a structure similar to that of poloxamers.

The dispersant can be used in the method according to the present invention in a concentration between ≧1 wt. % and ≦50 wt. %, preferably between ≧3 wt. % and ≦35 wt. %, more preferably between ≧5 wt. % and ≦25 wt. %.

Besides the method described above, the invention relates to the use of protein hydrolysates as a dispersant, wetting agent, flotation agent and/or as a washing active component of a detergent.

Surprisingly it has been found that protein hydrolysates in addition to their use as dispersants can also be used as wetting agent, flotation agent and/or washing active components of detergents due to their surface-active properties. In particular, the use of the protein hydrolysates described above as washing active components of detergents results in immense ecological and economic benefits.

Herein, the protein underlying the protein hydrolysate preferably comprises a consecutive sequence of amino acids with polar and nonpolar side groups.

Because of the high bioavailability of proteins such as keratin corresponding protein hydrolysates can be made available in large quantities at very reasonable prices. In addition, protein hydrolysates are completely biodegradable and therefore do not pose an environmental burden.

Thus it is possible in an advantageous manner, for example, to use the protein hydrolysate as a dispersant in a pigment-containing dispersion, preferably in a dispersion paint or a dispersion varnish or an oil-based pigment-containing dispersion such as a sunscreen.

Moreover, the protein hydrolysate can be used as a wetting agent in a composition for cleaning, for example, vehicle wheel rims. In particular, the contamination occurring at the vehicle wheel rims resulting from brake dust, oil, tar and gum residues requires a wetting agent having excellent dispersing properties in order to achieve a sufficient cleaning effect. So far, here often environmentally critical and often skin-irritating substances, such as phosphoric acid, have widely been used to dissolve the dirt adherent to the wheel rims. Herein, the phosphoric acid used may also damage, for example, light alloy wheel rims due to chemical reactions between the acid and the wheel rim material. It has been shown that protein hydrolysates, in particular keratin hydrolysates, are able to ensure a sufficient cleaning effect even in much less aggressive alkaline compositions.

A protein hydrolysate, such as a keratin hydrolysate, can advantageously be used even as a flotation agent in the processing of coal and/or ore. In this field, large amounts of surfactants are used to purify the desired ores/coals and to separate them from gangue. This is done in particular at the site of ore extraction, which is often situated in developing countries. Here often very insufficient means for drinking water treatment are present so that it cannot be excluded that surfactants passing into the water cycle find their way into the drinking water. Here, protein hydrolysates and in particular keratin hydrolysates offer the advantage that they are completely biodegradable and thus the risk of drinking water contamination can be reduced.

As a starting material for the provision of corresponding protein hydrolysates, for example, slaughterhouse waste such as feathers, obtained in very large quantities in poultry processing, can be suitable. These can be converted into the corresponding hydrolysate by suitable hydrolysis processes, which in turn may be provided as a solution or in a freeze-dried form.

Hereinafter the invention is explained in more detail with reference to exemplary embodiments.

### EXAMPLE 1

### Aqueous Titanium Dioxide Dispersion

Titanium dioxide powder (UV-Titan M262, Sachtleben GmbH) is added at room temperature to an aqueous solution of a keratin hydrolysate with a hydrolysate content of 25 wt. %. The ratio of the aqueous keratin hydrolysate solution to titanium dioxide powder is from 60 wt. % to 40 wt. %. The obtained mixture is homogenized by means of a dissolver disc or a wire stirrer as an agitating tool at a rotational speed between 2 and 10 m/s. This results in a stable titanium dioxide dispersion.

| Trade name | Manufacturer | CTFA/INCI | [wt. %] |
|---|---|---|---|
| Phase A | | | |
| Keratinhydrolysat | OTC GmbH | Hydrolyzed Keratin | 60.00 |
| (25%) | | | |
| Phase B | | | |
| UV-Titan M262 | Sachtleben GmbH | Titanium Dioxide, | 40.00 |
| | | Alumina, Dimethicone | |
| Total: | | | 100.00 |

### EXAMPLE 2

### Oil Based Titanium Dioxide Dispersion

A freeze-dried keratin hydrolysate in powder form is added at room temperature to a caprylic/capric acid triglyceride mixture (Rofetan GTCC, Univar GmbH) in a ratio by weigth of 1/10. A titanium dioxide powder (UV-Titan M262, Sachtleben GmbH) is added to the thus obtained phase. The resulting mixture is homogenized by use of a dissolver disc or a wire stirrer as an agitating tool at a rotation speed between 2 and 10 m/s and 5 wt. % water is added thereto with continued homogenization. This results in a stable oil based titanium dioxide dispersion.

| Trade name | Manufacturer | CTFA/INCI | [wt. %] |
|---|---|---|---|
| Phase A | | | |
| Keratinhydrolysat | OTC GmbH | Hydrolyzed Keratin | 5.00 |
| Pulver | | | |
| Rofetan GTCC | Univar GmbH | Caprylic/Capric | 50.00 |
| | | Triglyceride | |
| Phase B | | | |
| UV-Titan M161 | Sachtleben GmbH | Titanium Dioxide, | 40.00 |
| | | Alumina, Stearic Acid | |
| Phase C | | | |
| demin. Wasser | | Aqua/Water | 5.00 |
| Total: | | | 100.00 |

### EXAMPLE 3

### Aqueous Zinc Oxide Dispersion

A: Zinc oxide powder (Z-Cote, BASF AG) is added at room temperature to an aqueous solution of a keratin hydrolysate with a hydrolysate content of 25 wt. %. The ratio between the aqueous keratin hydrolysate solution and zinc oxide powder is 60 wt. % to 44 wt. %. The obtained mixture is homogenized with a dissolver disc or a wire stirrer as an agitating tool at a rotational speed between 4 and 8 m/s. This results in a stable zinc oxide dispersion.

B: Zinc oxide powder (Z-Cote MAX, BASF AG) is added at room temperature to an aqueous solution of a keratin hydrolysate with a hydrolysate content of 25 wt. %. The ratio between the aqueous keratin hydrolysate solution and zinc oxide powder is 60 wt. % to 40 wt. %. The obtained mixture is homogenized with a dissolver disc or a wire stirrer as an agitating tool at a rotational speed between 4 and 8 m/s. This results in a stable zinc oxide dispersion.

| | | | [wt. %] | [wt. %] |
|---|---|---|---|---|
| Trade name | Manufacturer | CTFA/INCI | A | B |
| Phase A | | | | |
| Keratinhydrolysat | OTC GmbH | Hydrolyzed | 56.00 | 60.00 |
| (25%) | | Keratin | | |
| Phase B | | | | |
| Z-Cote | BASF | Zinc Oxide | 44.00 | 0.00 |
| Z-Cote Max | BASF | Zinc Oxide, | 0.00 | 40.00 |
| | | Diphenyl Capryl | | |
| | | Methicone | | |
| Total: | | | 100.00 | 100.00 |

### EXAMPLE 4

### Wheel Rim Cleaner

30 wt. % of an aqueous keratin hydrolysate with a hydrolysate content of 25 wt. % are mixed with 10 wt. % of 1,3-butanediol, 10 wt % of a caprylyl/capryl glucoside, 1 wt. % of sodium hydrosulfide, 1 wt. % potassium hydroxide and 48 wt. % water to provide a detergent particularly for cleaning vehicle wheel rims. The mixture thus obtained exhibited an excellent cleaning efficiency with respect to typical oil and tar soilings.

| Trade name | Manufacturer | CTFA/INCI | [wt. %] |
|---|---|---|---|
| Phase A | | | |
| Keratinhydrolysat | OTC GmbH | Hydrolyzed Keratin | 30.00 |
| (25%) | | | |
| 1,3 Butandiol | Merck KGaA | Butylene Glycol | 10.00 |
| Plantacare 810 UP | Cognis | Caprylyl/Capryl | 10.00 |
| | Deutschland | Glucoside | |
| | GmbH | | |
| Natriumhydrosulfit | Brüggemann | Sodium Hydrosulfite | 1.00 |
| N | | | |
| KOH-Plätzchen | Merck KGaA | Potassium Hydroxide | 1.00 |
| demin. Wasser | | Aqua/Water | 48.00 |
| Total: | | | 100.00 |

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A method of dispersing a disperse phase in a liquid dispersion medium, comprising:
providing a liquid dispersion medium;
providing a disperse phase;
providing a dispersant; and
mixing the disperse phase with the liquid dispersion medium with the addition of the dispersant, wherein
a protein hydrolysate is added as a dispersant.

2. The method according to claim 1, wherein water, an aqueous solution or a hydrophobic solvent is provided as a dispersion medium.

3. The method according to claim 1, wherein a solid or a liquid phase which is immiscible in the provided dispersion medium is provided as the disperse phase.

4. The method according to claim 1, wherein a hydrolysate of a protein having a consecutive sequence of amino acids with polar and nonpolar side groups is provided as the protein hydrolysate.

5. The method according to claim 1, wherein a keratin hydrolysate is provided as a protein hydrolysate.

6. The method according to claim 1, wherein the dispersant of the dispersion to be prepared is added in a concentration of between ≧1 wt %, and ≦50 wt. %, preferably between ≧3 wt. %, and ≦35 wt. %, more preferably between ≧5 wt. % and ≦25 wt. %.

7. The method according to claim 1, wherein a pigment is provided as the disperse phase.

8. The method according to claim 7, wherein titanium dioxide and/or zinc oxide is provided as a disperse phase.

9. A method of dispersing a disperse phase, comprising contacting the disperse phase with a protein hydrolysate, wherein the protein hydrolysate is a dispersant, wetting agent, flotation aid and/or washing-active component in a detergent.

10. The method according to claim 9, wherein the protein underlying the protein hydrolysate comprises a consecutive sequence of amino acids with polar and nonpolar side groups.

11. The method according to claim 9, wherein the protein hydrolysate is a keratin hydrolysate.

12. The method according to claim 9, wherein the protein hydrolysate is used as a dispersant in a pigment-containing dispersion.

13. The method according to claim 9, wherein the protein hydrolysate is used as a wetting agent in a composition for cleaning vehicle wheel rims.

14. The method according to claim 9, wherein the protein hydrolysate is used as a flotation aid in the processing of coal and/or ore.

15. The method according to claim 12, wherein the pigment-containing dispersion is a dispersion paint, a dispersion varnish, or an oil based pigment-containing dispersion.

16. A composition comprising a protein hydrolysate and a solvent, wherein the composition is a dispersant, wetting agent, flotation aid, washing-active component in a detergent, or a combination thereof.

17. The composition according to claim 16, wherein the solvent is aqueous or hydrophobic.

18. The composition according to claim 16, wherein the protein hydrolysate comprises a consecutive sequence of amino acids with polar and nonpolar side groups.

19. The composition according to claim 16, wherein the protein hydrolysate is keratin hydrolysate.

20. The composition according to claim 16, wherein the protein hydrolysate has a concentration in the solvent of between 1 wt %, and 50 wt. %.
